(19) United States
(12) Patent Application Publication
(10) Pub. No.: US 2003/0191653 A1
(43) Pub. Date: Oct. 9, 2003

(54) Method for evaluating a test advertisement with redemptions of electronically distributed coupons

(76) Inventors: Dani Birnbaum, Cincinnati, OH (US); Alon Geva, New York, NY (US); Steve Hersh, New York, NY (US)

Correspondence Address: PENNIE & EDMONDS LLP, 1667 K STREET NW, SUITE 1000, WASHINGTON, DC, 20006

(21) Appl. No.: 10/116,060

(22) Filed: Apr. 5, 2002

(51) Int. Cl. G06F 17/60

(52) U.S. Cl. 705/1

(57) ABSTRACT

A method for comparing the efficacy of a plurality of test advertisements starts with distributing the advertisements over the internet. The plurality of test advertisements promote the same product or service. Upon viewing or hearing an advertisement distributed over the internet (an “imprint”), a viewer is given the option of printing out a coupon corresponding to the product or service referred to in the advertisement. Each printed coupon bears information that can be correlated with the particular test advertisement shown to the viewer who printed that coupon. The coupon server or other platform tracks the number of imprints of each test advertisement as well as the number of coupons printed as result of each test advertisement. After they have been redeemed, the coupons are subject to a clearing process. During the clearing process, the number of redeemed coupons corresponding to each test advertisement is tracked. Metrics can be derived from the number of imprints of each type of test advertisement, the number of coupons printed and the number of coupons redeemed. The raw numbers and/or these metrics, can be used to decide which, if any, of the test advertisements should be pursued or discontinued, in connection with a broader advertising campaign.

### RELATED APPLICATIONS

There are no related applications.

### FIELD OF THE INVENTION

The present invention was directed to the field called advertising wherein the organization wishes to determine the efficacy of a proposed advertising campaign. More particularly, it is directed to making decisions on which of a plurality of advertising campaigns should be pursued, based upon the redemption rate of coupons that are electronically distributed over the internet which are associated with particular test advertisements.

### BACKGROUND OF THE INVENTION

Manufacturers often promote their products and/or services through advertisements. In the case of television advertisements, a manufacturer commissions an advertising agency to prepare one or more advertisements for the same product or service. It is not atypical for a television advertisement lasting a mere thirty seconds to cost upwards of one half million dollars in production costs. When celebrities are retained for appearances in such advertisements, the costs can be even greater.

To determine which of a plurality of advertisements are effective, the manufacturer and/or advertising agency may turn to a research agency (which may be in-house). This research agency is tasked with determining which advertisement should be run. In the case of television advertisements, the research agency may run the advertisements in a few test markets and the poll viewers to determine whether or not they saw the advertisement, and, if so, their reaction to that advertisement. By running various test advertisements at different times and different locations and following these up with consumer surveys, the research agency is able to ascertain which of the test advertisements for the same product or service worked better than the others. However, the cost of producing the test advertisements added to the costs of performing the research on which of the test advertisements is best, is expensive.

Furthermore, such survey-based advertising testing methods for the purpose of determining effectiveness measures and projecting its impact on sales cannot track actual purchases that were generated directly from the advertisement impressions (i.e., the “exposures” of the advertisement to the viewers). The reason is that there is no easy and direct way to relate the advertisement exposure to the act of purchase. This is particularly difficult and critical for TV commercials.

While one can currently determine the immediate action of a consumer exposed to a Web advertisement message, for example (e.g. number of clicks on a banner or number of viewers of a streamed video), one cannot measure (quantitatively) the effect of such an advertising message on an actual offline purchase. And, for offline media (print and TV) even these “reach” and “frequency” measures are generally survey-based only. But there is no method to measure “purchase” as a result of an offline advertisement.

### SUMMARY OF THE INVENTION

In one aspect, the present invention uses an online system that can present an advertising message accompanied by a trackable printable coupon that can be used to purchase the product. This enables one to conduct a quantitative test that can measure how effective the advertising message was in generating sales in additional to prints and clicks. The coupon system enables printing from the Web and is trackable back to the advertising impression to which the user was presumably exposed to, in conjunction with the printing of this coupon.

The present invention is directed to a method for determining which of a plurality of advertisements is more effective in eliciting consumer response. This is achieved by displaying a plurality of advertisements for the same product or service over the internet, and inviting viewers to print electronic coupons corresponding to the product or service displayed. Upon viewing a test advertisement, a viewer is permitted to print an electronic coupon for that product or service. The printed electronic bears information which identifies the particular test advertisement that was viewed. When the viewer redeems the coupon at a point of sale, the coupon is processed through the regular coupon clearing house system. During the course of the clearing process, the number of coupons associated with each test advertisement is tabulated. Information about how many test advertisements were viewed, how many clicks for more information were obtained in response to the test advertisement, how many of each type of electronic coupon was printed, along with the number of each type of coupon redeemed, can be used as an indicator of the efficacy of the various test advertisements displayed on the internet. Efficacy metrics based on these numbers may also be created. These indicators and/or metrics can be used to make decisions about which of the test advertisements should be pursued and which should be set aside.

### BRIEF DESCRIPTION OF THE DRAWINGS

The present invention can better be understood through the figures in which:

FIG. 1 shows an overall flowchart of the present invention.

### DETAILED DESCRIPTION OF THE INVENTION

In the present invention, a number of viewers are exposed to a test advertisement. Preferably, the internet is used to deliver either the test advertisement itself, or information, such as a link, leading to the test advertisement.

When using email, the test advertisement may be delivered either in the message proper, as an attachment to the email, or a link may be sent in the email which the recipient must click upon to view to the test advertisement. When e-mail is used, it is generally distributed to a predetermined group of individuals who have agreed to serve as a “test panel” or “guinea pigs” for one or more test advertisements.

Alternatively, the test advertisements may be distributed by simply displaying them on predetermined websites at various times. In such case, the opportunity to view the test advertisements is given to whosoever happens to be visiting that web site at a particular instant in time. For instance, the test advertisement may be presented to a subscriber of an internet service provided at the time of log on. In such case, the advertising agency, research agency, manufacturer, or other entity interested in the outcome of the study, may contract with the internet service provider to present a predetermined number of such exposures at the time of log on. When two or more test advertisements are being run, an equal number of impressions of each may be purchased.

Instead of displaying the test advertisements at the time of log on, the test advertisements may be distributed at particular times, on particular websites, or in accordance with a host of other considerations.

The test advertisement may take one of several forms. For example, the test advertisement may be sent as a video image. Thus, it may comprise a videoclip distributed perhaps as a .avi file in an attachment. Alternatively, it may a streaming video, or other changing visual image, perhaps using flash or other technology. The content of the video data may be real imagery, animated imagery and animatics, among others. Alternatively, the advertisement, may be an audio advertisement such as a jingle or the like. In such case, the data may be sent as a .wav file attachment to an e-mail. Alternatively, it may be sent in streaming or other form, to a recipient. Still another possibility is a static visual ad, such as that one typically would find in a magazine or newspaper. Thus, a simple slogan, a photograph, or other still image may be presented. It is understood that the impressions presented to a viewer can takes the form of Banners, Pop-ups and HTML pages, among others. It is further understood that combinations of any of the foregoing may likewise be used.

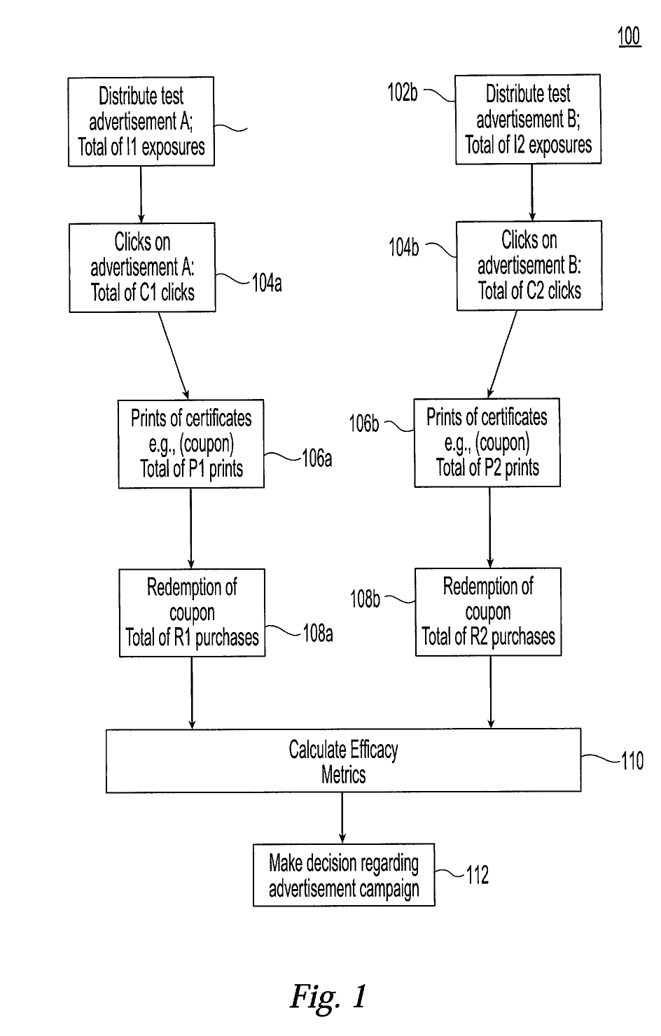

FIG. 1 depicts a flow diagram 100 of the steps involved in a first embodiment of the present invention, in which a plurality of test advertisements are being compared. This may be done to determine which of the two should be developed into a full-blown television advertisement. In this embodiment, a comparison of two different test advertisements, designated “A” and “B”, is made. Test advertisement A is distributed to individual members of a first group “Group A” while Group test advertisement B is distributed to individual members of a second group “Group B”. While test advertisements A and B have different content, they promote substantially the same product or service.

While in this embodiment, only two test advertisements are being distributed, it is understood that more than two test advertisements may be run, and so the present invention also contemplates evaluating one or more of test advertisements C, D, E, etc. with corresponding test groups C, D, E, etc., in addition to test advertisements A & B.

In step 102a, test advertisement A is distributed to members of Group A. The number of actual exposures Ii experienced by members of Group A is recorded. Similarly, in step 102b, test advertisement B is distributed to members of Group B. The number of actual exposures I1 experienced by members of Group A is recorded, as is the number of actual exposures 12 experienced by members of Group B. In one embodiment, the distribution of test advertisements A & B are performed during the same time period and in the same distribution channel (i.e, same web site or mode). In another embodiment, test advertisements A & B are distributed either at different times or in different distribution channels, or both.

In steps 104a, 104b, after being exposed by either viewing or listening to a test advertisement, a viewer belonging to either Group A or Group B, respectively, is presented with an opportunity to click on a button, icon or image to obtain further information. The opportunity to obtain additional information may be presented as a button, link or other clickable object on the viewer's screen. The number of clicks C1,C2 corresponding to each test advertisement, A and B, respectively, is recorded. As is known to those skilled in the art, the number of clicks for additional information, by itself, is an indication of the appeal of the corresponding test advertisement.

After a viewer has clicked for additional information, in steps 106a, 106b, the viewer is provided with an opportunity to print a coupon for the product or services promoted by the test advertisement. The printed coupon includes conventional information such as the UPC code associated with the product or service and the coupon. In addition, the printed coupon bears information that can be correlated with the particular test advertisement shown to a viewer who printed that coupon. The number of printed coupons, P1, P2, associated with each test advertisement A and B, respectively, is recorded by a coupon server or other platform tasked with keeping track of this information.

In a preferred embodiment, each printed coupon has a unique identification number. A database operated by the coupon distributor (or other entity interested in the outcome of the test advertisement campaign) keeps track of several attributes associated with that unique identification number. These attributes may include such things as the identity of the viewer who printed the coupon, the website on which the coupon was displayed, the time of day the coupon was printed, and the product or service to which the service pertains, among others. This and other information may be used to track the behavior of the viewers, among other things.

People skilled in the art are familiar with distributing coupons over the internet, assigning unique identifiers to printed coupons and establishing and maintaining the databases associated with keeping track of the recorded information. Therefore, these details are not included here.

In Steps 108a, 108b, the viewers in Groups A and B, respectively, redeem the coupons that they have printed. The redeemed coupons are sent through the normal clearing process. During this process, the number of redeemed coupons R1, R2 corresponding to the two types of test advertisements are tracked and recorded.

Next, in step 110, the collected information is presented to the research agency, advertising agency, manufacturer or other interested party. Efficacy metrics may then be calculated based on the raw collected information, i.e., the number of exposures, I1, I2 for each test advertisement, the number of clicks C1, C2 made upon viewing each test advertisement, the number of coupons printed P1, P2, and the number of coupons actually redeemed R1, R2.

For example, a first ratio of the number of coupons redeemed to the number of exposures may be calculated for each test advertisement A and B. A second ratio of the number of coupons printed to the number of exposures may be calculated for each test advertisement A and B. A third ratio of the number of clicks for additional information to the number of exposures may be calculated for each test advertisement A and B. It should be noted that not all of these metrics have to be calculated, and that other efficacy metrics, such as those comparing the number of coupons redeemed to the number clicks, may also be calculated. It should also be noted that calculation of these metrics may be skipped, and the raw numbers themselves used in any decision making process.

Finally, in step 112, the raw collected information and/or one or more of the efficacy metrics may then be used to decide the next step in an advertising campaign.

One possibility is that one of the two test advertisements is found to be better at eliciting a response (e.g., printing the coupon or redeeming the coupon). Such information can then be used to determine which if any advertisements should be used in a more expansive marketing campaign. It is also possible that both test advertisements are found to be disappointing. In such case, new test advertisements may be developed and distributed over the internet.

Comparative Test Advertising Example

In a hypothetical example, a manufacturer of a consumer product is planning a TV campaign for a new product. Before spending a large amount of money to shoot a TV commercial, two different concepts are compared by creating a sketch video for each and distributing both over the internet, by displaying the videos on web sites. The following data and metrics is obtained:

TABLE 1
Result of Hypothetical Test Advertisement Study

| | Test Advertisement A | Test Advertisement B |
|---|---|---|
| # of Exposures | 10,000 | 10,000 |
| # of Clicks | 1,000 | 1,100 |
| # of Printed Coupons | 100 | 115 |
| # of Redeemed Coupons | 50 | 30 |
| Clicks/Exposures Metric | 0.10 | 0.11 |
| Prints/Exposures Metric | 0.01 | 0.0115 |
| Redeem/Exposures | 0.005 | 0.003 |
| Metric | | |

In the above hypothetical example, even though Test Video B generated more clicks and prints, the research shows that Test Video A is more effective to generate actual purchases of the advertised product, based on the number of coupons redeemed. Therefore, in this example, the manufacturer would likely choose to proceed with the concept associated with Test Video A. Also, in the above example, the number of exposures for the two test advertisements are the same, and so one may directly compare the raw numbers without taking any ratios. It should be noted, however, that even if the number of exposures for each test advertisement were different, one may still use the ratio metrics to evaluate their efficacy.

In the embodiment described above, a comparison between two or more test advertisements is made. In an alternative embodiment, the same type of research can be conducted to evaluate a single test advertisement. The same types of data are collected and the same types of metrics may be calculated. The results may then be compared against a database of prior test advertisement results. Based on these comparisons, a decision may be made as to whether to proceed with the tested concept.

The above research may be conducted to evaluate any message type, including a finished TV commercial (but tested over the Web). The results can be compared to each other or to a database of past results for benchmarking. This type of research may be useful in deciding which, if any, commercial should be run during a broadcast time slot for which air time is expensive.

In the foregoing description, the goal was to ascertain the efficacy of a test advertisement to see whether a particular advertising concept should be further pursued. It should be kept in mind, however, that the general concept of tracking the redemption of coupons can be used to evaluate more than simply the efficacy of an advertisement. In other words, the test “variable” may be something other than the content of the test advertisement. For instance, one may use the collected information to evaluate different target audiences, different impression levels (“reach” and/or “frequency”), response levels of viewers in different geographical area, etc. These test designs can simulate larger offline (or online) media plans and provide insight into the effectiveness of various media plans. Furthermore, a test can be designed to capture product usage feedback. Such data in conjunction with advertising testing can be used to estimate repeat and overall volume potentials (volumetrics) of a specific campaign or product launch. In all cases a trackable certificate is used in conjunction with the advertising message.

A test advertisement study may be accompanied by a survey while the coupon is being presented. A test advertisement study may be followed-up by contacting the purchasers (i.e., the people who printed and then redeemed the coupon). For instance, the study may be followed by a recall survey after a period of time, a post-usage survey to learn about product appeal, a survey to determine future purchase intent, and even additional advertising messages and/or coupons to assess attitudes and behavior from multiple engagements over time. Such post-coupon-redemption surveys and actions can be performed when the purchaser's contact information is known. This is possible when the redeemed coupons bear information that is traceable to the purchaser. This can happen if, for example, a unique identification number is printed on each coupon and a database includes an entry mapping the unique identification number to the purchaser. The mapping may be correlated to the purchaser's e-mail address, phone number, mailing address or other contact information. The contact information may have been provided in those cases where the purchaser has agreed to participate in the test advertising study, or in exchange for some benefit provided to the purchaser, or perhaps even as part of the terms of the service to which the purchaser is bound.

While in the above description, the term “coupon” was used to describe the printed item that is redeemed, it is understood that any trackable printed certificate can be used. Thus, in addition to “cents off” coupons, one may use a gift certificate, a rebate offer, or the like. Other such certificates are also possible.

Finally, while the present invention has been described with reference to certain preferred embodiments, it should be kept in mind that the invention is not limited to these. Variations of the above may well be within the present invention, whose extent is given by the scope of the claims presented below. It should also be kept in mind, that practicing the claimed invention need not necessarily result in any, let alone all, of the advantages and benefits discussed above.

What is claimed is:

1. A method of comparing the efficacy of a plurality of test advertisements, comprising the steps of:
distributing said plurality of test advertisements over the internet;
distributing a printable certificate over the internet, wherein each certificate, when printed, bears information that can be correlated with the particular test advertisement shown to a viewer who printed that certificate;
determining how many of the printed certificates have been redeemed; and
evaluating the efficacy of each test advertisement, based at least in part on the numbers of printed certificates that have been redeemed.

2. The method according to claim 1, wherein each printed certificate is one from the group consisting of a cents-off coupon, a gift certificate, or a rebate certificate.

3. The method according to claim 1, further comprising:
keeping track of the numbers of viewers exposed to each of the plurality of test advertisements.

4. The method according to claim 1, further comprising:
keeping track of the numbers of clicks made in response to each of the plurality of test advertisements, each click being indicative of a request for additional information associated with the test advertisement to which a corresponding viewer was exposed.

5. The method according to claim 1, further comprising:
keeping track of the numbers of certificates printed that are associated with each of the plurality of test advertisements.

6. The method according to claim 1, further comprising:
keeping track of the numbers of viewers exposed to each of the plurality of test advertisements;
keeping track of the numbers of clicks made in response to each of the plurality of test advertisements, each click being indicative of a request for additional information associated with the test advertisement to which a corresponding viewer was exposed; and
keeping track of the numbers of certificates printed that are associated with each of the plurality of test advertisements.

7. The method according to claim 6, further comprising:
calculating at least one ratio among the number of certificates redeemed, the number of clicks made, and the number of certificates printed to the number of viewers exposed, for each of the plurality of test advertisements.

8. The method according to claim 1, further comprising:
developing at least one of the plurality of test advertisements into an expanded advertising campaign, based at least in part on the numbers of printed certificates that have been redeemed.

9. A method of evaluating a test advertisement comprising the steps of:
distributing the test advertisement over the internet;
distributing a printable certificate over the internet, wherein the certificate, when printed, bears information that can be correlated with the test advertisement shown to a viewer who printed that certificate;
determining how many of the printed certificates have been redeemed; and
evaluating the efficacy of the test advertisement, based at least in part on the number of printed certificates that have been redeemed.

10. The method according to claim 9, wherein each printed certificate is one from the group consisting of a cents-off coupon, a gift certificate, or a rebate certificate.

11. The method according to claim 9, further comprising:
keeping track of the number of viewers exposed to the test advertisement.

12. The method according to claim 9, further comprising:
keeping track of the number of clicks made in response to the test advertisement, each click being indicative of a request for additional information associated with the test advertisement.

13. The method according to claim 9, further comprising:
keeping track of the number of certificates printed.

14. The method according to claim 9, further comprising:
keeping track of the number of viewers ex posed to the test advertisement.
keeping track of the number of clicks made in response to the test advertisement, each click being indicative of a request for additional information associated with the test advertisement; and
keeping track of the number of certificates printed.

15. The method according to claim 14, further comprising:
calculating at least one ratio among the number of certificates redeemed, the number of clicks made, and the number of certificates printed to the number of viewers exposed.

16. The method according to claim 9, wherein the steep of evaluating the efficacy of the test advertisement comprises comparing results of the test advertisement against a database of prior test advertisement results.
